(19) United States
(12) Patent Application Publication
(10) Pub. No.: US 2023/0176703 A1
(43) Pub. Date: Jun. 8, 2023

(54) TOUCH/PEN SENSORS WITH PEDOT FILMS

(71) Applicant: HEWLETT-PACKARD DEVELOPMENT COMPANY, L.P., Spring, TX (US)

(72) Inventors: Fred Charles Thomas, III, Fort Collins, CO (US); Christian M. Damir, Fort Collins, CO (US); Robert Scott Rawlings, Fort Collins, CO (US); Mario E. Campos, Spring, TX (US); Cheng Huang, Palo Alto, CA (US); Bruce Eric Blaho, Fort Collins, CO (US)

(73) Assignee: HEWLETT-PACKARD DEVELOPMENT COMPANY, L.P., Spring, TX (US)

(21) Appl. No.: 17/922,566

(22) PCT Filed: Apr. 30, 2020
(86) PCT No.: PCT/US2020/030768

§ 371 Date: Oct. 31, 2022

(51) Int. Cl. G06F 3/044

(52) U.S. Cl. CPC G06F 3/0446; G06F 3/0445; G06F 3/0447

(57) ABSTRACT

An example of a flexible sensor stack includes a flexible film comprising a conformal polymer film or a flexible glass film. The flexible sensor stack includes first and second conformal poly(3,4-ethylenedioxythiophene) (PEDOT) films formed over the flexible film and including sensor traces to provide a flexible touch/pen (T/P) sensor surface, wherein the flexible sensor stack is bendable to conform to a non-flat attachment surface.

### BACKGROUND

Some computing devices employ touch-based input methods that allow a user to physically touch, for example, an associated display, and have that touch registered as an input at the particular touch location, thereby enabling a user to interact physically with objects shown on the display of the computing device. Digital pens may also be used in conjunction with computing devices and provide a natural and intuitive way for users to input information into applications running on the computing devices.

### BRIEF DESCRIPTION OF THE DRAWINGS

FIG. 1 is a diagram illustrating a touch/pen sensor system according to an example.

FIG. 2 is a block diagram illustrating elements of the sigma-delta analog-to-digital controller shown in FIG. 1 according to an example.

FIGS. 3A-3B are layer diagrams illustrating layers of a flexible touch/pen sensor according to some examples.

FIG. 3C is a diagram illustrating a flexible touch/pen sensor formed on a non-flat surface of an object according to an example.

FIG. 4 is a block diagram illustrating a computing system with a touch/pen sensor system according to an example.

FIG. 5 is a block diagram illustrating a flexible sensor stack according to an example.

FIG. 6 is a flow diagram illustrating a method of forming a flexible touch/pen sensor surface according to an example.

FIG. 7 is a block diagram illustrating a touch/pen sensor according to an example.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Some examples disclosed herein are directed to a flexible or conformal touch/pen (T/P) sensor for a non-flat surface. The term “touch/pen” or “T/P” sensor as used herein includes touch-based interfaces, pen-based interfaces, and interfaces that are both touch-based and pen-based. The T/P sensor may conform to the non-flat surface. The T/P sensor may be built into a conformal cosmetic film product, such as a vinyl skin or wrap for a car or other objects. In other examples, the T/P sensor may be built into a flexible glass product. The T/P sensor according to some examples provides the ability for a user to interact with a non-flat surface in a touch imaging manner where the sensor surface can capacitively image what is touching it (e.g., finger/hand/stylus/object/face).

The T/P sensor may include a flexible or conformal sensor stack. The sensor stack may include a conformal polymer film or a flexible glass film, and a conformal projected capacitive (p-cap) poly(3,4-ethylenedioxythiophene) (PEDOT) film formed on the conformal polymer film or flexible glass film front and back sides. The PEDOT films may be impedance-conditioned or etched with p-cap array sensors to enable touch and stylus interactions on their non-flat surfaces. The PEDOT film is an optically clear, electrically-conductive layer that may be fabricated into a row and column p-cap sensor array.

The flexible or conformal sensor stack may be used in combination with an analog-to-digital (A-to-D) sampling controller. The A-to-D sampling controller may be a sigma-delta A-to-D sampling controller that has drive and sense electrodes operated in parallel and that aggressively filters out noise from the measured voltage-based capacitive signals. PEDOT based p-cap sensors may have a higher sheet resistance (and hence signal noise limitations) than sensors based on other materials, such as indium-tin-oxide (ITO), silver nanowire, metal mesh, and carbon nano-tube, but have a much lower variance in sheet resistance than the other materials. Sheet resistance is a measure of resistance of thin films that are nominally uniform in thickness. Sheet resistance is a special case of resistivity for a uniform sheet thickness. The units for sheet resistance are ohms per square. Some example PEDOT films have a high sheet resistance (e.g., about 225 ohms/sq), and a low variance of sheet resistance (e.g., about plus or minus 1% to 3%) over the entire film. In contrast, examples of ITO on plastic have a sheet resistance of about 150 ohms/sq, and a variance of sheet resistance of about plus or minus 25%. Examples of silver nanowire have a sheet resistance of about 20 ohms/sq, and a variance of sheet resistance of about plus or minus 40%. A “high” sheet resistance as used herein means a sheet resistance of at least 200 ohms/sq. A “low” variance of sheet resistance as used herein means a variance of sheet resistance of less than plus or minus 5%. The sigma-delta A-to-D sampling controller is able to filter out this noise, which allows a material, such as PEDOT, with a low variance in sheet resistance, to be used effectively. In some examples, the sigma-delta controller is able to image a single touch sensor surface at between 100 and 600 frames per second.

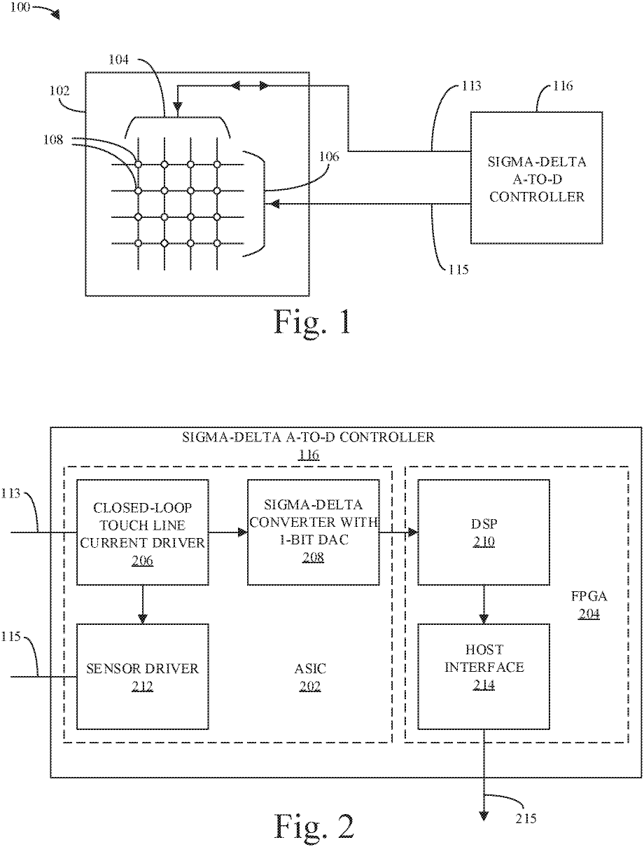

FIG. 1 is a diagram illustrating a touch/pen sensor system 100 according to an example. System 100 includes T/P device 102, and sigma-delta analog-to-digital (A-to-D) controller 116.

Device 102 includes a plurality of sense electrodes 104, a plurality of drive electrodes 106, and a plurality of capacitive nodes 108. The sense electrodes 104 are conductive traces represented by a plurality of equally spaced vertical lines, and the drive electrodes 106 are conductive traces represented by a plurality of equally spaced horizontal lines. The intersections of the sense electrodes 104 and the drive electrodes 106 correspond to the locations of the capacitive nodes 108.

The sense electrodes 104 and drive electrodes 106 may be used to sense the position of a pen tip or other object. In some examples, the sense electrodes 104 and drive electrodes 106 are about 3-5 mm wide, with a pitch of about the same or a little wider (e.g., 4-6 mm). For this disclosure, the density or locality of more highly dense grids may be distributed over a non-flat object that this flexible T/P sensor is covering. For example, on a car there may be a dense capacitive node matrix grouping near car access points like the door handle and trunk/boot key lock. Sensing of position of a digital pen with a fine tip (e.g., about 0.5 mm to 2 mm diameter or less) may involve triangulation of tip location using multiple signals from the trace intersections closest to the pen tip point touch down location, and also other trace crossings surrounding the touch down location.

The sense electrodes 104 are coupled via communication link 113 to controller 116 to provide sense signals to the controller 116. In an example, communication link 113 includes a separate conductive line for each of the sense electrodes 104. The drive electrodes 106 are coupled via communication link 115 to controller 116 to provide drive signals from the controller 116 to the drive electrodes. In an example, communication link 115 includes a separate conductive line for each of the drive electrodes 106.

In some examples, the T/P device 102 may include a p-cap PEDOT film with rows, and a p-cap PEDOT film with columns, with these films being on opposite sides of a plastic or glass film.

FIG. 2 is a block diagram illustrating elements of the sigma-delta analog-to-digital (A-to-D) controller 116 shown in FIG. 1 according to an example. In an example, controller 116 includes a hybrid analog/digital application specific integrated circuit (ASIC) 202 and a digital field programmable gate array (FPGA) 204. ASIC 202 includes closed-loop touch line current driver 206, sigma-delta converter with 1-bit digital to analog converter (DAC) 208, and sensor driver 212. FPGA 204 includes digital signal processor (DSP) 210 and host interface 214. In an example, ASIC 202 is an analog front-end (AFE) with a data rate of about 300 to 600 frames per second (i.e., 300 to 600 Hz), and ASIC 202 drives and reads up to 64 channels in parallel.

Closed-loop touch line current driver 206 is coupled to sensor driver 212 to facilitate the generation of drive signals. Sensor driver 212 outputs analog drive signals via communication link 115. The closed-loop drive current on each electrode supports long electrodes and electrode variability. In some examples, the drive signals provide increased channel isolation and noise suppression.

Closed-loop touch line current driver 206 receives analog sense signals via communication link 113, and provides the analog sense signals to sigma-delta converter 208. In some examples, the driving and sensing of each electrode occurs individually and in parallel. Sigma-delta converter 208 performs a delta-sigma modulation process, and converts the analog sense signals into digital sense signals, which are output to DSP 210.

In some examples, sigma-delta converter 208 encodes analog signals using high-frequency delta-sigma modulation, and then applies a digital filter to form a higher-resolution but lower sample-frequency digital output. Delta-sigma modulation involves delta modulation in which the change in the signal (i.e., its delta) is encoded, resulting in a stream of pulses. Accuracy of the modulation may be improved by passing the digital output through a 1-bit DAC and adding (sigma) the resulting analog signal to the input signal (the signal before delta modulation), thereby reducing the error introduced by the delta modulation.

DSP 210 performs of the digital sense signals received from sigma-delta converter 208, and touch/pen image extraction. DSP 210 provides full touch/pen images to host interface 214. In some examples, DSP 210 also performs touch processing (e.g., finger/pen coordinates, palm rejection, gesture interpretation, etc.). In an example, host interface 214 outputs the full touch/pen images via a communication link 215 or conversely it provides touch/pen coordinate information universal serial bus (USB)/inter-integrated circuit (I2C) human interface device (HID) packets to a host device. In some cases, host interface 214 may provide both touch image as well as USB/I2C packets to a host device.

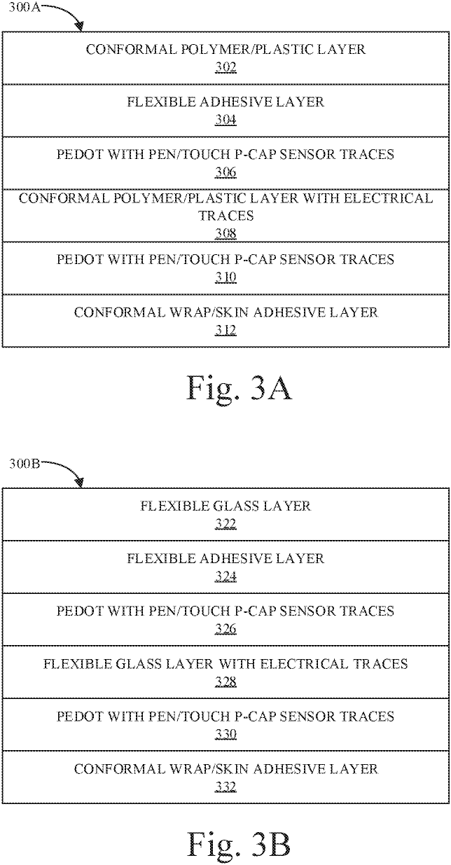

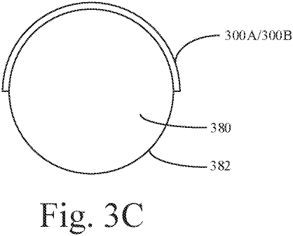

FIGS. 3A-3B are layer diagrams illustrating layers of a flexible touch/pen (T/P) sensor according to some examples. As shown in FIG. 3A, flexible T/P sensor 300A includes conformal polymer/plastic layer 302, flexible adhesive layer 304, PEDOT with pen/touch p-cap sensor traces layer 306, conformal polymer/plastic layer with electrical traces 308, PEDOT with pen/touch p-cap sensor traces layer 310, and conformal wrap/skin adhesive layer 312.

In an example, layer 302 has a thickness of 25 um to 100 um; layer 304 has a thickness of 50 um; layer 306 has a thickness of 0.1 um to 0.9 um; layer 308 has a thickness of 25 um to 100 um; layer 310 has a thickness of 0.1 um to 0.9 um; and layer 312 has a thickness of 50 um.

The PEDOT layers 306 and 310 are clear, electrically-conductive layers that are fabricated into row and column p-cap sensor arrays, which are formed on a conformal polymer/plastic layer, such as layer 308. In some examples, the three layers 306, 308, and 310 are a conformal p-cap vinyl sensor stack. In some examples, the drive conductive traces (i.e., drive electrodes) for the p-cap vinyl sensor stack are in layer 306, and the sense conductive traces (i.e., sense electrodes) for the p-cap vinyl sensor stack are in layer 310. The fabrication process may include increasing the surface resistance of portions/areas of the PEDOT film by orders of magnitude via wet-printing of the PEDOT film with a chemical agent. In contrast, fabrication processes for other materials typically involve adding trace material to the layer or etching material off the layer. Compared to other materials that have been used for T/P sensor surfaces, example PEDOT films are less expensive, have a lower index of refraction, are more flexible/bendable, and have a lower variance in sheet resistance across the layer, which is typically about plus or minus two percent. Example PEDOT films have an index of refraction of 1.5. In contrast, example ITO films have an index of refraction of 2.1. The highly uniform sheet resistance (e.g., a variance in sheet resistance of less than plus or minus 5%) of the PEDOT layer translates into nodes having a more uniform capacitance over the layer than materials with a higher variance in sheet resistance (e.g., higher than plus or minus 5%).

In some examples, the conformal polymer/plastic layer 302 is a top layer that faces a user and is the farthest layer from the surface to which the T/P sensor 300A is attached. The conformal polymer/plastic layer 302 may be opaque and colorized. The conformal polymer/plastic layers 302 and 308 may be vinyl layers. Vinyl or polyvinyl chloride (PVC) material is a semi-ridged and flexible face stock that conforms to curved surfaces and forms well over minor surface irregularities. Vinyl is used in a variety of applications including: vehicle wraps, fleet graphics, labels, decals, safety, warning and danger labels, markings for exterior cut lettering for vehicles, overlays, faceplates, and decorative trim and striping. Example vinyl layers for layers 302 and 308 include a vinyl wrap, or a carbon fiber vinyl wrap. In other examples, the conformal polymer/plastic layers 302 and 308 may each be a silicone-based cross-linked polymer layer (XPL) that mimics the mechanical and elastic properties of human skin. Other types of polymers may also be used for layers 302 and 308. The conformal wrap/skin adhesive layer 312 is a bottom layer that may be conformally adhered to a surface (e.g., non-flat surface) of an object.

As shown in FIG. 3B, flexible T/P sensor 300B includes flexible glass layer 322, flexible adhesive layer 324, PEDOT with pen/touch p-cap sensor traces layer 326, flexible glass layer with electrical traces 328, PEDOT with pen/touch p-cap sensor traces layer 330, and conformal wrap/skin adhesive layer 332.

In an example, layer 322 has a thickness of 100 um to 200 um; layer 324 has a thickness of 50 um; layer 326 has a thickness of 0.1 um to 0.9 um; layer 328 has a thickness of 100 um to 200 um; layer 330 has a thickness of 0.1 um to 0.9 um; and layer 332 has a thickness of 50um.

The PEDOT layers 326 and 330 are clear, electrically-conductive layers that are fabricated into row and column p-cap sensor arrays, which are formed on a flexible glass layer, such as layer 328. In some examples, the three layers 326, 328, and 330 are a flexible p-cap glass sensor stack. In some examples, the drive conductive traces (i.e., drive electrodes) for the flexible p-cap glass sensor stack are in layer 326, and the sense conductive traces (i.e., sense electrodes) for the flexible p-cap glass sensor stack are in layer 330. The fabrication process may include increasing the surface resistance of portions/areas of the PEDOT film by orders of magnitude via wet-printing of the PEDOT film with a chemical agent.

In some examples, the flexible glass layer 322 is a top layer that faces a user and is the farthest layer from the surface to which the T/P sensor 300B is attached. In some examples, the flexible glass layer 322 may be replaced with a vinyl layer. The conformal wrap/skin adhesive layer 332 is a bottom layer that may be conformally adhered to a surface (e.g., non-flat surface) of an object. FIG. 3C is a diagram illustrating a flexible touch/pen (T/P) sensor 300A/300B formed on a non-flat surface 382 of an object 380 according to an example. The flexible T/P sensor 300A/300B may be used for a variety of different applications, including security, access determination, information retrieval, biometric sensing, communications (e.g., a mobile phone with the flexible T/P sensor), gaming (e.g., a gaming device with the flexible T/P sensor), touch-based drug infusions, as well as other applications. The flexible T/P sensor 300A/300B may be applied to a variety of different non-flat surfaces, such as surfaces for vehicles, windows and glass, buildings, walls, floors, signs, and displays, as well as other surfaces. The flexible T/P sensor 300A/300B may be used to provide touch and stylus location sensing for curved displays, building windows with an internal touch layer, car windows with touch, display windows with touch, as well as others.

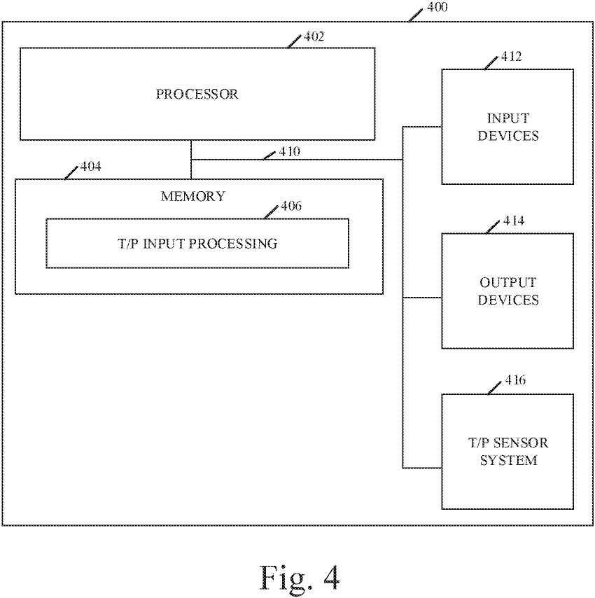

FIG. 4 is a block diagram illustrating a computing system 400 with a touch/pen sensor system according to an example. System 400 includes processor 402, memory 404, input devices 412, output devices 414, and touch/pen (T/P) sensor system 416. Processor 402, memory 404, input devices 412, output devices 414, and T/P sensor system 416 are communicatively coupled to each other through communication link 410. In an example, T/P sensor system 416 may be implemented with the T/P sensor system 100 shown in FIG. 1, and may include any of the flexible T/P sensors 300A-300C (FIGS. 3A-3C). T/P sensor system 416 represents a T/P-enabled interface that enables T/P-based interaction between a user and a non-flat surface of an object.

Processor 402 includes a central processing unit (CPU) or another suitable processor. In an example, memory 404 stores machine readable instructions executed by processor 402 for operating system 400. Memory 404 includes any suitable combination of volatile and/or non-volatile memory, such as combinations of Random-Access Memory (RAM), Read-Only Memory (ROM), flash memory, and/or other suitable memory. These are examples of non-transitory computer readable media (e.g., non-transitory computer-readable storage media storing computer-executable instructions that when executed by at least one processor cause the at least one processor to perform a method). The memory 404 is non-transitory in the sense that it does not encompass a transitory signal but instead is made up of at least one memory component to store machine executable instructions for performing techniques described herein.

Memory 404 stores T/P input processing module 406. Processor 402 executes instructions of T/P input processing module 406 to perform techniques described herein.

Input devices 412 include a keyboard, mouse, data ports, stylus or digital pen, and/or other suitable devices for inputting information into system 400. Output devices 414 include speakers, data ports, and/or other suitable devices for outputting information from system 400.

T/P sensor system 416 may track the position of, for example, a user’s finger, a stylus, or a digital pen, on a display and/or touch pad, and output corresponding touch information to T/P input processing module 406 for processing. The input device may be any elongated device that a user may hold and touch to a surface.

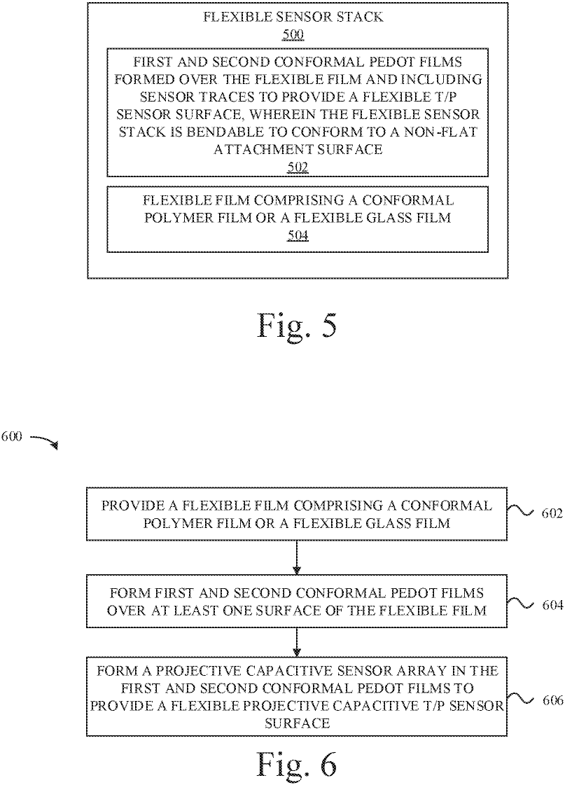

An example is directed to a flexible sensor stack. FIG. 5 is a block diagram illustrating a flexible sensor stack 500 according to an example. Flexible sensor stack 500 includes a flexible film 504 comprising a conformal polymer film or a flexible glass film. Flexible sensor stack 500 also includes first and second conformal PEDOT films 502 formed over the flexible film 504 and including sensor traces to provide a flexible touch/pen (T/P) sensor surface, wherein the flexible sensor stack 500 is bendable to conform to a non-flat attachment surface.

The PEDOT films 502 may be fabricated to form a projective capacitive sensor array. The projective capacitive sensor array may be controlled by a sigma-delta controller. The flexible film 504 may be the conformal polymer film, and the conformal polymer film may be a conformal vinyl film. The flexible film 504 may be the flexible glass film, and the flexible glass film may have a thickness in the range of 100 to 150 micrometers. Each of the PEDOT films 502 may have a thickness in the range of 0.1 to 1.0 micrometers. The flexible film 504 may have a thickness in the range of 25-150 micrometers.

The first conformal PEDOT film 502 may be formed over a first surface of the flexible film 504, and the second conformal PEDOT film may be formed over a second surface of the flexible film 504. The second conformal PEDOT film may include projective capacitive row sensor traces for the T/P sensor surface. The first conformal PEDOT film may include projective capacitive column sensor traces relative to the projective capacitive row sensor traces of the second conformal PEDOT.

Another example is directed to a method of forming a flexible touch/pen sensor surface. FIG. 6 is a flow diagram illustrating a method 600 of forming a flexible touch/pen sensor surface according to an example. At 602, the method 600 includes providing a flexible film comprising a conformal polymer film or a flexible glass film. At 604, the method 600 includes forming first and second conformal PEDOT films over at least one surface of the flexible film. At 606, the method 600 includes forming a projective capacitive sensor array in the first and second conformal PEDOT films to provide a flexible projective capacitive touch/pen (T/P) sensor surface.

Method 600 may further include forming the first conformal PEDOT film over a first surface of the flexible film; and forming the second conformal PEDOT film over a second surface opposite the first surface of the flexible film. Method 600 may further include forming conductive PEDOT traces in the flexible film for the flexible T/P projective capacitive sensor surface.

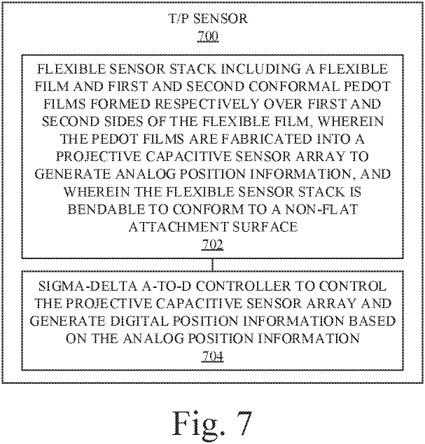

Another example is directed to a touch/pen sensor. FIG. 7 is a block diagram illustrating a touch/pen (T/P) sensor 700 according to an example. T/P sensor 700 includes a flexible sensor stack 702 including a flexible film and first and second conformal PEDOT films formed respectively over the first and second sides of the flexible film, wherein the PEDOT films are fabricated into a projective capacitive sensor array to generate analog position information, and wherein the flexible sensor stack is bendable to conform to a non-flat attachment surface. T/P sensor 700 also includes a sigma-delta analog-to-digital (A-to-D) controller 704 to control the projective capacitive sensor array and generate digital position information based on the analog position information. The flexible film may include one of a conformal polymer film or a flexible glass film.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A flexible sensor stack, comprising:
a flexible film comprising a conformal polymer film or a flexible glass film; and
first and second conformal poly(3,4-ethylenedioxythiophene) (PEDOT) films formed over the flexible film and including sensor traces to provide a flexible touch/pen (T/P) sensor surface, wherein the flexible sensor stack is bendable to conform to a non-flat attachment surface.

2. The flexible sensor stack of claim 1, wherein the PEDOT films are fabricated to form a projective capacitive sensor array.

3. The flexible sensor stack of claim 2, wherein the projective capacitive sensor array is to be controlled by a sigma-delta controller.

4. The flexible sensor stack of claim 1, wherein the flexible film is the conformal polymer film, and wherein the conformal polymer film is a conformal vinyl film.

5. The flexible sensor stack of claim 1, wherein the flexible film is the flexible glass film, and wherein the flexible glass film has a thickness in the range of 100 to 150 micrometers.

6. The flexible sensor stack of claim 1, wherein each of the PEDOT films has a thickness in the range of 0.1 to 1.0 micrometers.

7. The flexible sensor stack of claim 1, wherein the flexible film has a thickness in the range of 25-150 micrometers.

8. The flexible sensor stack of claim 1, wherein the first conformal PEDOT film is formed over a first surface of the flexible film, and wherein the second conformal PEDOT film is formed over a second surface of the flexible film.

9. The flexible sensor stack of claim 8, wherein the second conformal PEDOT film includes projective capacitive row sensor traces for the T/P sensor surface.

10. The flexible sensor stack of claim 9, wherein the first conformal PEDOT film includes projective capacitive column sensor traces relative to the projective capacitive row sensor traces of the second conformal PEDOT film.

11. A method, comprising:
providing a flexible film comprising a conformal polymer film or a flexible glass film;
forming first and second conformal poly(3,4-ethylenedioxythiophene) (PEDOT) films over at least one surface of the flexible film; and
forming a projective capacitive sensor array in the first and second conformal PEDOT films to provide a flexible projective capacitive touch/pen (T/P) sensor surface.

12. The method of claim 11, and further comprising:
forming the first conformal PEDOT film over a first surface of the flexible film; and
forming the second conformal PEDOT film over a second surface opposite the first surface of the flexible film.

13. The method of claim 12, and further comprising:
forming conductive PEDOT traces in the flexible film for the flexible T/P projective capacitive sensor surface.

14. A touch/pen (T/P) sensor, comprising:
a flexible sensor stack including a flexible film and first and second conformal poly(3,4-ethylenedioxythiophene) (PEDOT) films formed respectively over first and second sides of the flexible film, wherein the PEDOT films are fabricated into a projective capacitive sensor array to generate analog position information, and wherein the flexible sensor stack is bendable to conform to a non-flat attachment surface; and
a sigma-delta analog-to-digital (A-to-D) controller to control the projective capacitive sensor array and generate digital position information based on the analog position information.

15. The T/P sensor of claim 14, wherein the flexible film comprises a conformal polymer film or a flexible glass film.
